(19) United States
(12) Patent Application Publication
(10) Pub. No.: US 2007/0069550 A1
(43) Pub. Date: Mar. 29, 2007

(54) Deflector with a positioning device for a car

(75) Inventor: Lin-Mei Tsai, Taichung City (TW)

Correspondence Address: EGBERT LAW OFFICES, 412 MAIN STREET, 7TH FLOOR, HOUSTON, TX, 77002, US

(73) Assignee: KENG LIEN INDUSTRIAL CO., LTD., Taichung City (TW)

(21) Appl. No.: 11/401,067

(22) Filed: Apr. 10, 2006

(30) Foreign Application Priority Data
Sep. 23, 2005 (TW) 094216479

(51) Int. Cl. B62D 35/00

(52) U.S. Cl. 296/180.1

(57) ABSTRACT

The present invention provides a deflector with a positioning device for a car including a deflector unit with two ends, a fastener unit, a connecting unit, and a supporting unit. Each end of the deflector unit has at least two sliding grooves installed on the car body with the connecting unit and fastener unit. The fastener unit includes two fastener plates and a positioning component. The connecting unit includes two connecting bars and a universal joint, each connecting bar being fastened to the first and second connecting ends of the sliding groove of the deflector unit. The other end of the connecting bar has a fastening bar section, which can fasten to the fastening edge of the fastener plate. The supporting unit is set between the deflector unit and car body for a buffering effect. The invention allows for convenient assembly and installation without drilling, while maintaining stability and practicality.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a deflector, and more particularly to a deflector installed to the body of a car and considered to be a type of car accessory.

### BACKGROUND OF THE INVENTION

To improve the smoothness and stability of driving, it is common to install a deflector on the outside of a car body. FIG. 1 shows the assembled view of a conventional deflector 01, which is often installed on the car body 03 via connecting frames 02 on the two sides. The installation method of the connecting frame 02 is often via screwing or adhesion. The screw method is by boring holes on the car body to lock the bolts 04, but this method damages the sheet metal of the car body 03 and allows water or mist to go through the holes in the car during rain or a carwash. The adhesion method has the disadvantage of deterioration or hardening of the adhesive after a period of use, and results in a loosened deflector 01.

Another problem is that different makes of cars have different widths; thus, deflectors of different sizes are needed. The conventional deflectors are made for specific makes of cars, and cannot be used on a car with a different make and size. Hence, the practicality of the deflector is limited.

Also, the boring technology used in the screwing method often requires skilled workers and professional tools. It could only be done by auto shops or professional workers, resulting in inconvenient assembly and high costs.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

1. The deflector is fastened to the side B (such as the engine hood, and trunk hood) of the car body via a fastener unit 20, and the deflector is connected to the connecting unit 30 via a universal joint 40. The deflector of the present invention requires no drilling on the car body nor using adhesives, thus the car body is not damaged. The fastener plate 21 of the fastener unit 20 could be fastened to the car body so that the deflector 10 could be secure and durable.

2. The sliding groove 11 of the deflector 10 and the first and second connecting ends 311 312 of the connecting bar 31 could be fine tuned before the bolt 45 of the universal joint 40 is fastened, so that the deflector 10 could be adjusted to the suitable position for different makes of cars.

3. The universal joint 40 has the feature of universal direction, so that the first and second connecting ends 311 312 of the connecting bar 31 could follow the arc surface of the deflector 10, and allow the connecting part to fit smoothly.

4. The supporting unit 50 provides support and a buffer to the deflector 10, and the supporting unit 50 improves the quality of the deflector device. Also, the supporting block 51 has several ring grooves 511 spaced in equal length to be used as reference for cutting of the supporting block 51.

5. The fastener unit 20 contains a wear-resisting spacer 23, which is placed at one side B of the fastener unit 20. The bottom of the wear-resisting spacer 23 can allow the positioning component 22 to lean on. The top surface can allow the fastening bar section 313 of the connecting bar 31 to lean on, so as to prevent the positioning component 22 and the fastening bar section 313 from having direct contact with the car body and resulting in damage.

6. The ball connector 41 has a coupling end 411, which is connected with the connecting end 311 or 312 of the connecting bar 31 to form a spiral design. It allows the ball connector 41 to be fine tuned with the screw. When the first and second connecting ends 311 312 of the connecting bar 31 and the sliding groove 11 of the deflector 10 are positioned, the ball connector 41 can be fine tuned for tightening. So, the deflector 10 and the connecting bar 31 are more secured.

### BRIEF DESCRIPTION OF THE SEVERAL VIEWS OF THE DRAWINGS

FIG. 1 shows a perspective view of the conventional deflector.

FIG. 2 shows an exploded perspective view of the deflector of the present invention.

FIG. 3 shows a perspective view of the deflector in an assembled state.

FIG. 4 shows an enlarged perspective view of part A of FIG. 3.

FIG. 5 shows a cross-sectional view of the fastener unit of the present invention.

FIG. 6 shows an elevation view of the adjustment of the deflector of the present invention.

FIG. 7 shows a perspective view of the supporting block that can be cut to adjust heights.

FIG. 8 shows an exploded perspective view of the universal joint of the present invention.

FIG. 9 shows a cross-sectional view of the universal joint of the present invention.

FIGS. 10-11 show cross-sectional views of the universal movement of the ball connector of the universal joint shown in FIG. 9.

FIG. 12 shows a perspective view of another embodiment of the assembly of the deflector.

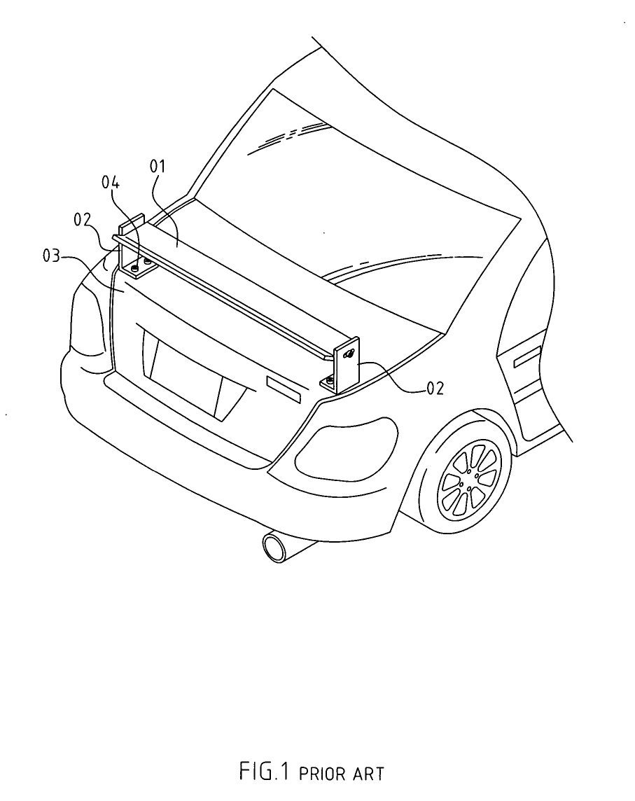

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

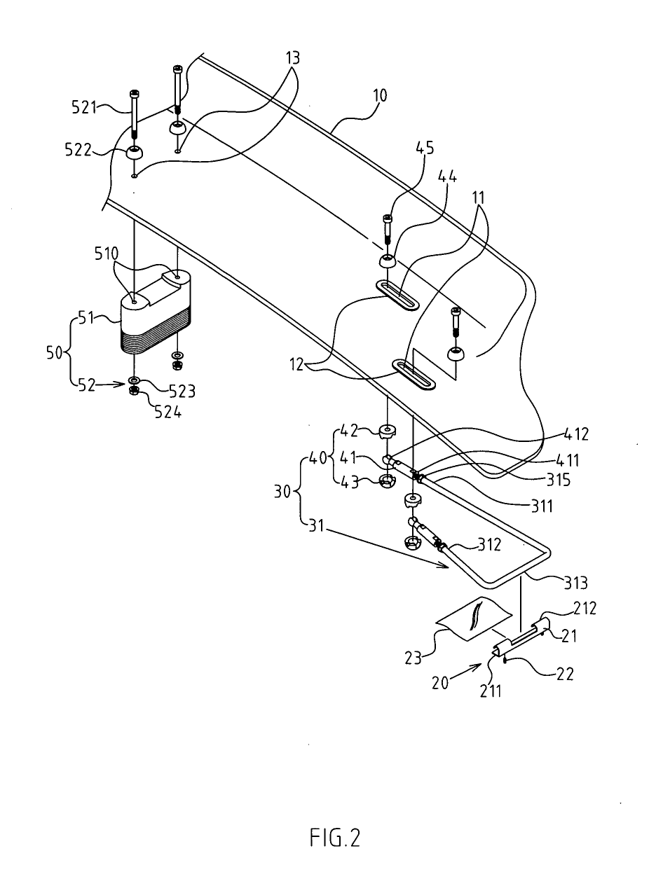

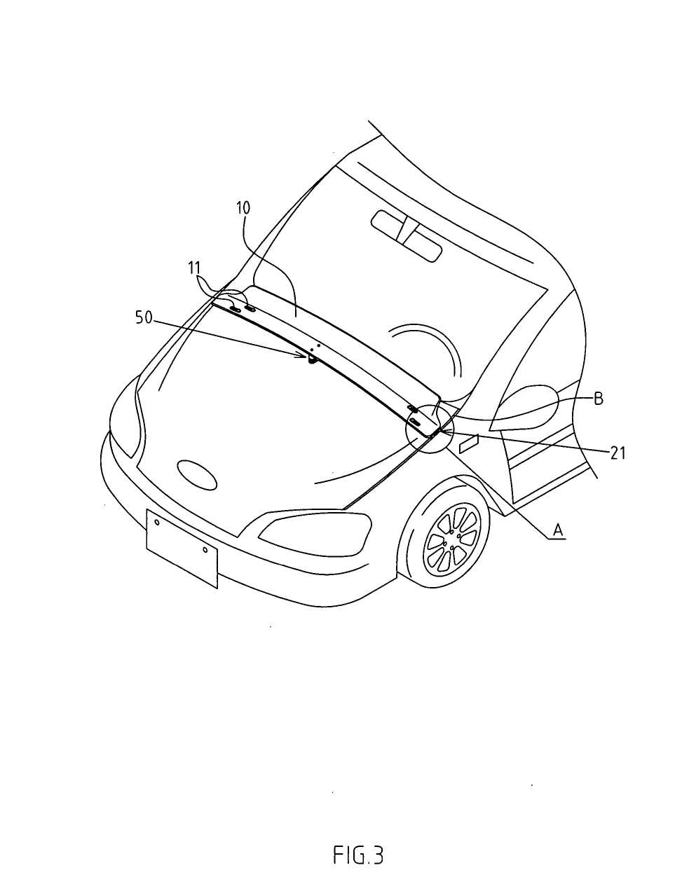

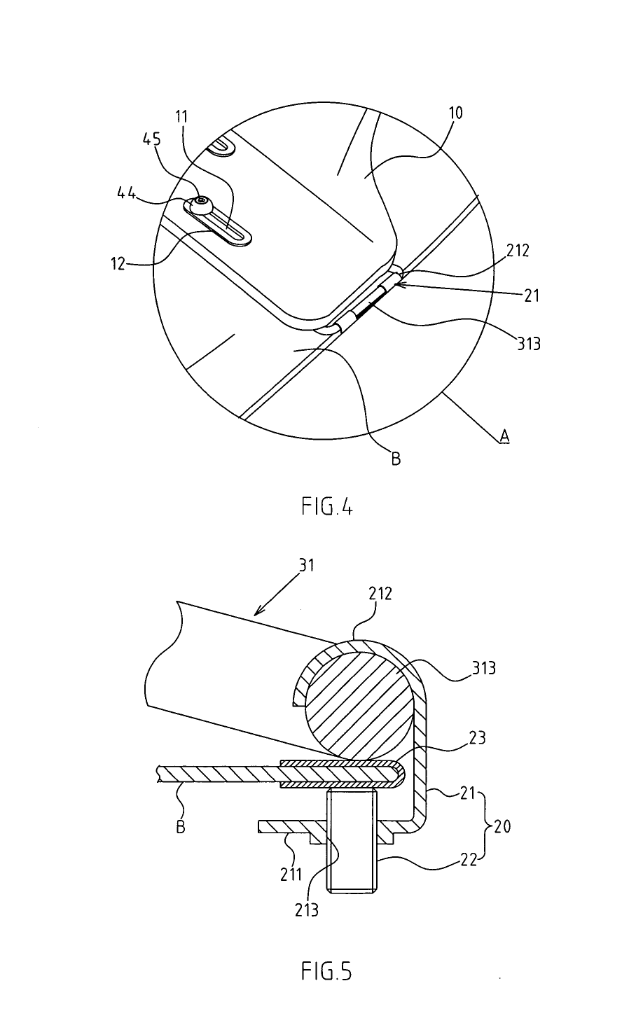

As shown in FIGS. 2-3, there is a preferred embodiment of a deflector and its positioning device for car, which is shown only for illustration and does not limit the patent scope.

The present invention has a deflector 10 with two ends, each having at least two sliding grooves 11. The shape of the sliding groove could be an elliptic hole; the two sliding grooves 11 on the same end are staggered; and the sliding groove 11 could be fitted with a sheath 12. The middle section of the deflector 10 has two connecting holes 13.

A fastener unit 20 contains at least two fastener plates 21. A positioning component 22 affixes the fastener plate 21 to the pre-determined side, such as the side of the hood, of the car body. The fastener plate 21 comprises a bottom positioning edge 211 and top fastening edge 212. The cross-section of the fastener plate 21 can be a Π shape, the positioning edge 211 can be a plane, and the fastening edge 212 can be an arc. The positioning edge 211 has two through screw holes 213, which can be screwed by two bolts to form the positioning component 22. The fastener unit 20 may contain wear-resisting spacer 23, used as illustrated in FIG. 5, which is in a U-shape and placed at one side B of the fastener unit 20. The bottom of the wear-resisting spacer 23 can allow the positioning component 22 to lean on and prevent it from having direct contact with the car body and resulting in damage.

A connecting unit 30 includes two connecting bars 31 and a universal joint 40. The connecting bar 31 is in a Π shape and forms a first connecting end 311 and a second connecting end 312 extending toward the sliding groove 11 of the deflector 10. The section of the connecting bar 31 that is between the first and second connecting ends 311 312 is a fastening bar section 313, which can be fastened to the fastening edge 212 of the fastener plate 21. The fastening bar section 313 can lean against the top of the said wear-resisting spacer 23. The first and second connecting ends 311 312 are staggered from the sliding groove 11 of the deflector 10 in uneven lengths.

The universal joint 40 of the connecting unit 30 comprises: a ball connector 41, an upper spherical socket 42, a lower spherical socket 43, a positioning base 44, and a bolt 45.

The ball connector 41 has one end as the coupling end 411, which is connected with the connecting end 311 or 312 of the connecting bar 31. The other end is a spherical connector 412, which has a through hole 413.

The upper spherical socket 42 is at the upper part of the spherical connector 412 of the ball connector 41. The upper spherical socket 42 has a semi-spherical socket 421, which matches up with the upper part of the spherical connector 412. One side of the semi-spherical socket 421 has a concave edge 422, which can avoid the ball connector 41. The upper spherical socket 42 has a boring hole 423, which faces the through hole 413 of the ball connector 41. The top 424 of the upper spherical socket 42 is leaned against the bottom of the sliding groove 11 of the deflector 10.

The lower spherical socket 43 is at the lower part of the spherical connector 412 of the ball connector 41. The lower spherical socket 43 has a semi-spherical socket 431, which matches up with the lower part of the spherical connector 412. One side of the semi-spherical socket 431 has a concave edge 432 to avoid the ball connector 41. The lower spherical socket 43 has a screw hole 433, which faces the through hole 413 of the ball connector 41.

The positioning base 44 leans against the top of the sliding groove 11 of the deflector 10. The positioning base 44 has a boring hole 441, which faces the boring hole 423 of the sliding groove 11 and the upper spherical socket 42.

The bolt 45 has a screw thread that goes through the boring hole 441 of the positioning base 44, the sliding groove 11 of the deflector 10, the boring hole 423 of the upper spherical socket 42, the through hole 413 of the ball connector 41, and the screw hole 433 of the lower spherical socket 43 in the said sequence.

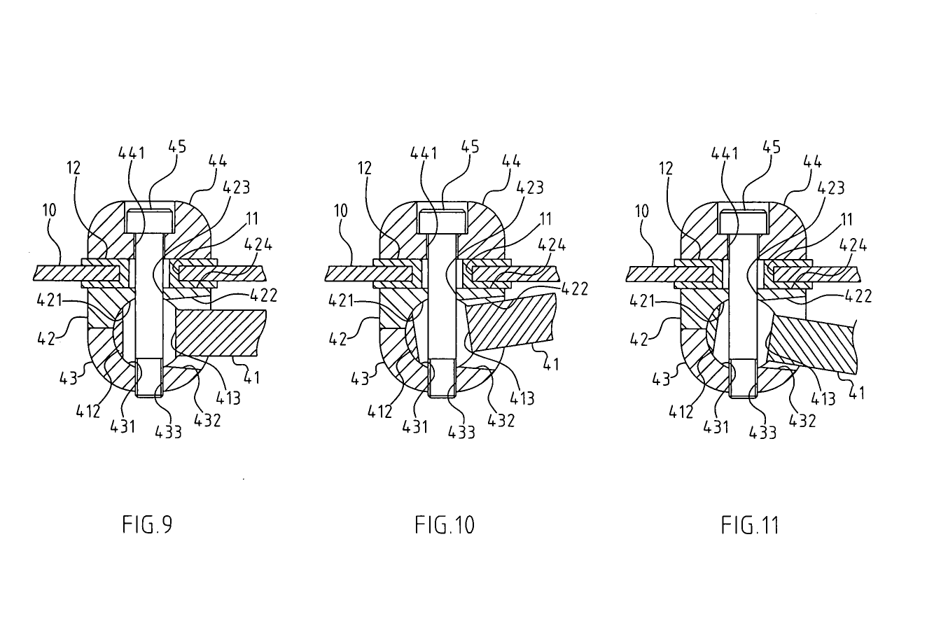

The coupling end 411 of the ball connector 41 can be a screw hole, so that the connecting end 311 or 312 of the connecting bar 31 can have corresponding screw threads 314 and can be screwed with the ball connector 41. The ball connector 41 can be fine tuned with the screwing function. The screw threads 314 have a nut 315, which fasten the ball connector 41 to the position. The upper and lower spherical sockets 42 43 can have protruding edge 424 and concave edge 434 for positioning. After the bolt 45 is tightened, the spherical connector 412 is limited to the spherical surface between the upper and lower spherical sockets 42 43. It forms the ball connector 41 with universal movement, as shown in FIGS. 10 and 11.

The present invention also includes a supporting unit 50, which comprises a supporting block 51 and a positioning fitting 52. The supporting block 51 can be affixed to the pre-determined position of the deflector 10 via the positioning fitting 52. As shown in the embodiment, the supporting block 51 is affixed to the middle section of the deflector 10. The appearance is a hollow column. The top of the supporting block 51 has two holes 510, which face the connecting holes 13 of the deflector 10. The positioning fitting 52 comprises a bolt 521, a top button 522, a spacer 523, and a nut 524.

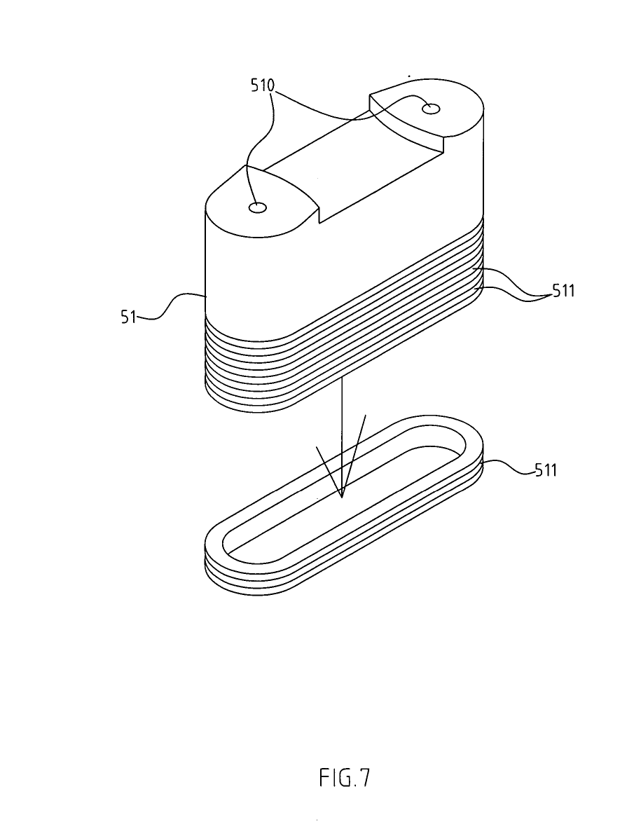

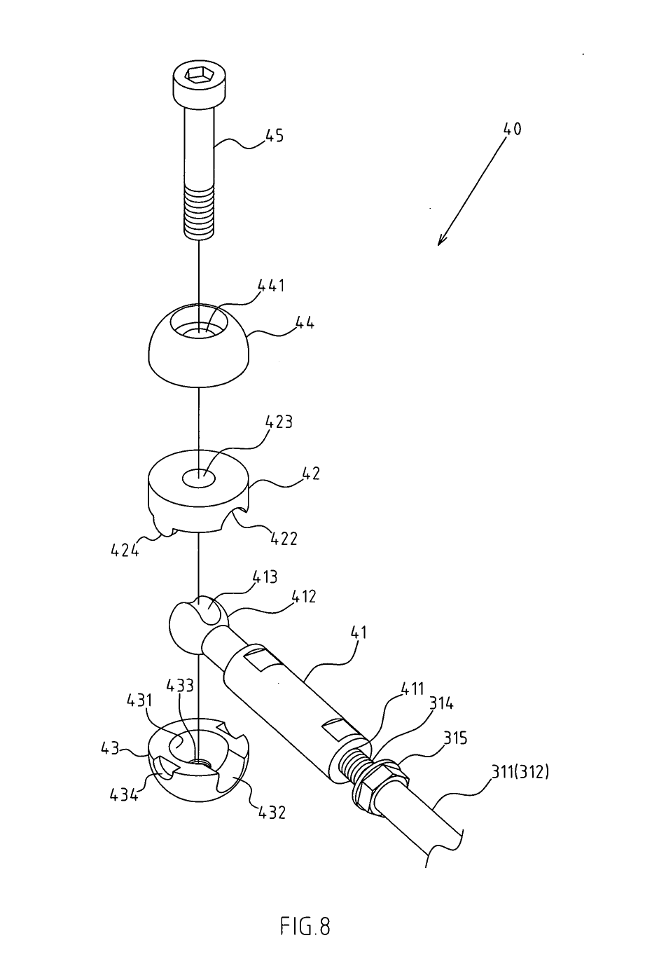

The supporting block 51, as shown in FIG. 7, can be sliced into suitable pieces to support the height. The bottom section of the supporting block 51 can have several ring grooves 511 spaced in equal length to be used as reference for cutting.

The assembly procedures of the deflector device of the present invention are detailed as follows.

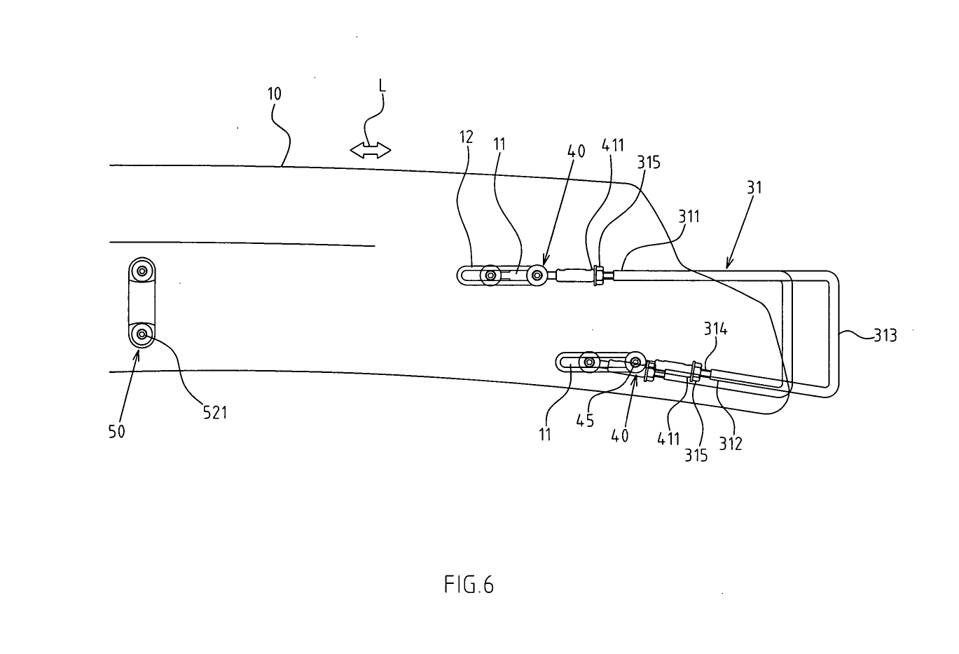

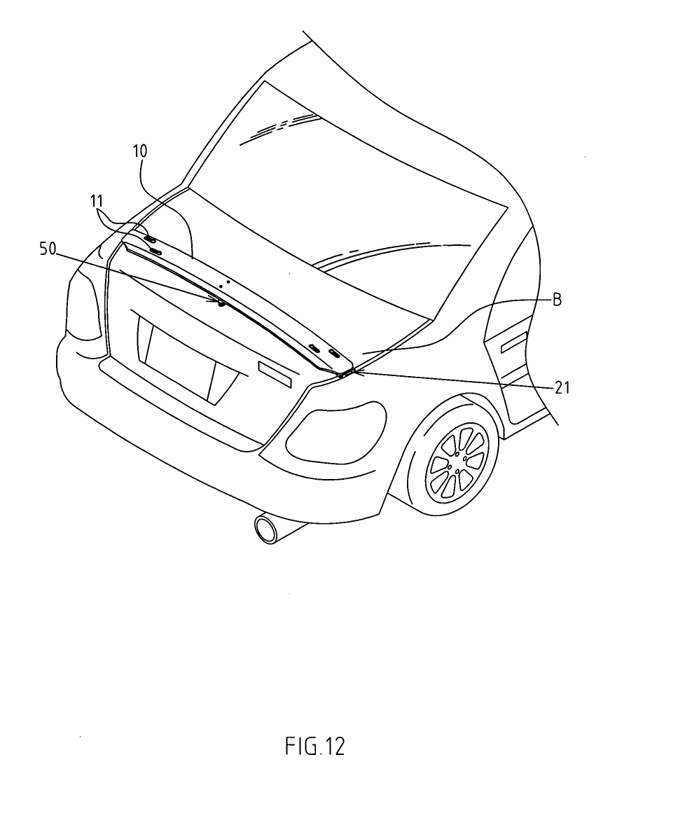

The deflector 10 can be installed on the engine hood (as shown in FIG. 3), or trunk hood (as shown in FIG. 12). To install the deflector 10 on the car, as shown in FIG. 5, the fastening bar section 313 of the connecting bar 31 of the connecting unit 30 is fastened to the fastening edge 212 of the fastener plate 21 of the fastener unit 20. Then, the wear-resisting spacer 23 is wrapped on the pre-determined side B of the car body. The fastener plate 21 is affixed to the car body via a positioning component 22, when the fastener plate 21 is secured. The fastening bar section 313 of the connecting bar 31 is secured as well. The first and second connecting ends 311 312 of the connecting bar 31 are connected to the sliding groove 11 of the deflector 10. The universal joint 40 is connected with the first and second connecting ends 311 312 and the sliding groove 11 of the deflector 10, before the bolt 45 of the universal joint 40 is fastened. Since the sliding groove 11 is an elliptic hole, the deflector 10 could be adjusted to a proper position (as shown in FIG. 6 by the arrow L). The universal movement of the universal joint 40 can allow the first and second connecting ends 311 312 of the connecting bar 31 to follow the arc design of the deflector 10 so that the parts can be fitted securely. The bolt 45 of the universal joint is screwed to complete the positioning of the deflector 10.

I claim:

1. A deflector with a positioning device for a car, said deflector comprising:
a deflector unit with two ends, each end having at least two sliding grooves;
a fastener unit being comprised of at least two fastener plates, and a positioning component affixed to a fastener plate, the fastener plate being comprised of a bottom positioning edge and top fastening edge; and
a connecting unit being comprised of two connecting bars and a universal joint, each connecting bar forming a first connecting end and a second connecting end extending toward the sliding groove of the deflector unit, an opposite end of the connecting bar having a fastening bar section, being fastenable to the fastening edge of the fastener plate.

2. The deflector with a positioning device as defined in claim 1, wherein the two sliding grooves on are shaped as elliptic holes and staggered, so that the first and second connecting ends form different lengths.

3. The deflector with a positioning device as defined in claim 1, wherein the fastener plate has a cross-section in a Π shape, the positioning edge being a plane, the fastening edge being an arc; and wherein the positioning edge has through screw holes, which can be screwed by bolts, forming the positioning component.

4. The deflector with a positioning device as defined in claim 1, wherein the connecting bar has a Π shape.

5. The deflector with a positioning device as defined in claim 1, wherein the deflector unit is comprised of a supporting unit, said supporting unit being comprised of a supporting block and a positioning fitting, said supporting block being affixed to a pre-determined position of the deflector unit via the positioning fitting.

6. The deflector with a positioning device as defined in claim 1, wherein said universal joint comprises:
a ball connector, one end thereof being a coupling end connected with the connecting end of said connecting bar, another end being a spherical connector and having a through hole;
a upper spherical socket, being located at an upper part of the spherical connector and having a semi-spherical socket matching up with the upper part of the spherical connector, one side of the semi-spherical socket having a concave edge avoiding said ball connector, the upper spherical socket having a boring hole facing a through hole of the ball connector, a top of the upper spherical socket being leaned against a bottom of the sliding groove;
a lower spherical socket, being located at a lower part of the spherical connector and having a semi-spherical socket, matching up with the lower part of the spherical connector, one side of the semi-spherical socket having a concave edge avoiding said ball connector, the lower spherical socket having a screw hole facing the through hole of the ball connector;
a positioning base leaned against a top of the sliding groove of the deflector unit, the positioning base having a boring hole facing boring holes of the sliding groove and the upper spherical socket; and
a bolt, having screw thread through the boring hole of the positioning base, the sliding groove of the deflector unit, the boring hole of the upper spherical socket, the through hole of the ball connector, and the screw hole of the lower spherical socket in sequence.

7. The deflector with a positioning device as defined in claim 6, wherein the coupling end of the ball connector is a screw hole, so that the connecting end of the connecting bar has corresponding screw threads and is in screwing engagement with the ball connector, the ball connector being fine tuned with a screwing function and secured, said screw threads having a nut fastening the ball connector in position.

8. The deflector with a positioning device as defined in claim 6, wherein the upper and lower spherical sockets have protruding and concave edges for positioning.

9. The deflector with a positioning device as defined in claim 1, wherein said fastener unit comprises a wear-resisting spacer.

10. A deflector positioning device for car, comprising:
a fastener unit, being comprised of at least two fastener plates, and a positioning component affixed to a fastener plate, said fastener plate being comprised of a bottom positioning edge and top fastening edge;
a connecting unit, being comprised of two connecting bars and a universal joint, each of said connecting bar forming a first connecting end and a second connecting end extending toward a same direction, another end of the connecting bar having a fastening bar section, being fastened to the fastening edge of the fastener plate.

11. The deflector positioning device as defined in claim 10, wherein the fastener plate has a cross-section in a Π shape, the positioning edge being a plane, the fastening edge being an arc; and wherein the positioning edge has through screw holes, being screwed by bolts to form the positioning component.

12. The deflector positioning device as defined in claim 10, wherein the connecting bar is in a Π shape.

13. The deflector positioning device as defined in claim 10, further comprising:
a supporting unit, having a supporting block and a positioning fitting.

14. The deflector positioning device as defined in claim 10, wherein the universal joint of the connecting unit comprises:
a ball connector, one end thereof being a coupling end connected with the connecting end of said connecting bar, another end being a spherical connector and having a through hole;
a upper spherical socket, being located at an upper part of the spherical connector and having a semi-spherical socket matching up with the upper part of the spherical connector, one side of the semi-spherical socket having a concave edge avoiding said ball connector, the upper spherical socket having a boring hole facing a through hole of the ball connector, a top of the upper spherical socket being leaned against a bottom of the sliding groove;
a lower spherical socket, being located at a lower part of the spherical connector and having a semi-spherical socket, matching up with the lower part of the spherical connector, one side of the semi-spherical socket having a concave edge avoiding said ball connector, the lower spherical socket having a screw hole facing the through hole of the ball connector;
a positioning base leaned against a top of the sliding groove of the deflector unit, the positioning base having a boring hole facing boring holes of the sliding groove and the upper spherical socket; and
a bolt, having screw thread through the boring hole of the positioning base, the sliding groove of the deflector unit, the boring hole of the upper spherical socket, the through hole of the ball connector, and the screw hole of the lower spherical socket in sequence.

15. The deflector positioning device as defined in claim 14, wherein the coupling end of the ball connector is a screw hole, so that the connecting end of the connecting bar has corresponding screw threads and is in screwing engagement with the ball connector, the ball connector being fine tuned with a screwing function and secured, said screw threads having a nut fastening the ball connector in position.

16. The deflector positioning device as defined in claim 14, wherein the upper and lower spherical sockets have protruding and concave edges for positioning.

17. The deflector positioning device as defined in claim 10, wherein said fastener unit comprises a wear-resisting spacer.
